(19) United States
(12) Patent Application Publication
(10) Pub. No.: US 2021/0093122 A1
(43) Pub. Date: Apr. 1, 2021

(54) BASTING AND INJECTION APPARATUS AND METHOD OF USE

(71) Applicant: Marvin DuBose, (US)

(72) Inventor: Marvin DuBose, Lometa, TX (US)

(21) Appl. No.: 16/589,727

(22) Filed: Oct. 1, 2019

(51) Int. Cl. A47J 36/32; A47J 37/10; A23P 20/18

(52) U.S. Cl. CPC A47J 36/321; A23P 20/18; A47J 37/106

(57) ABSTRACT

An apparatus including a timer connected to a housing. The timer includes a time display and a control mechanism for controlling the timer. A pump is inside the housing and connected to the timer. A switch is connected to the timer and to the pump. The switch controls operation of the pump according to a signal received from the timer. A power source is connected to the pump. An inlet tube and an outlet tube are connected to the pump. The inlet tube extends outside the housing through a first housing opening. The outlet tube extends outside the housing through a second housing opening. A manifold is connected to the outlet tube. Hollow needles are connected to the manifold to receive the liquid pumped through the pump, through the outlet tube, and into the manifold.

### BACKGROUND

Some food preparation activities call for periodically basting, injecting, or otherwise covering a food product with a liquid. For example, while cooking a turkey it may be desirable to inject the turkey with a liquid, such as turkey broth. It may also be desirable to baste the outside of the turkey with the liquid, or to both inject and baste the turkey. Additionally, certain other meats or food products may be periodically basted or marinated with herb and spice-infused liquids or sauces during food preparation.

### SUMMARY

In general, in one aspect, one or more embodiments relate to an apparatus including a housing and a timer connected to the housing. The timer includes a time display observable outside the housing and further comprising a control mechanism for controlling operation of the timer. The apparatus also includes a pump disposed inside the housing and operably connected to the timer, the pump configured to pump a liquid. The apparatus also includes a switch operably connected to the timer and to the pump. The switch is configured to control operation of the pump according to a signal received from the timer. The apparatus also includes a power source disposed inside the housing and operably connected to the pump. The apparatus also includes an inlet tube having a first opening and a second opening. The inlet tube is connected to the pump at the first opening of the inlet tube. The inlet tube extends outside the housing through a first housing opening such that the second opening of the inlet tube is external to the housing. The apparatus also includes an outlet tube having a third opening and a fourth opening. The outlet tube is connected to the pump at the third opening of the outlet tube. The outlet tube extends outside the housing through a second housing opening such that the fourth opening of the outlet tube is external to the housing. The apparatus also includes a manifold connected to fourth opening of the outlet tube. The apparatus also includes hollow needles connected to the manifold to receive the liquid pumped through the pump, through the outlet tube, and into the manifold.

One or more embodiments also relate to a method of manufacturing an apparatus. The method includes connecting a timer within a housing and connecting a power source within the housing and to the timer. The method also includes connecting a switch within the housing and to the timer. The method also includes connecting a pump within the housing to the switch and to the power source. The method also includes connecting an inlet tube through the housing and to the pump, the inlet tube extending externally from the housing. The method also includes connecting a first end of an outlet tube through the housing and to the pump, the outlet tube extending externally from the housing. The method also includes connecting a manifold to a second end of the outlet tube, opposite the first end. The method also includes connecting a plurality of hollow needles to the manifold.

One or more embodiments also include an apparatus including a housing and a timer. The timer includes a time display and further comprising a control mechanism for controlling operation of the timer. The apparatus also includes a pump disposed inside the housing and operably connected to the timer. The pump is configured to pump a liquid. The apparatus also includes a switch operably connected to the timer and to the pump. The switch is configured to control operation of the pump according to a signal received from the timer. The apparatus also includes an inlet tube having a first opening and a second opening. The inlet tube is adapted to be connected to the pump at the first opening of the inlet tube, and is adapted to extend outside the housing such that the second opening of the inlet tube is external to the housing. The apparatus also includes an outlet tube having a third opening and a fourth opening. The outlet tube is adapted to be connected to the pump at the third opening of the outlet tube, and is adapted to extend outside the housing such that the fourth opening of the outlet tube is external to the housing. The apparatus also includes a manifold adapted to be connected to the fourth opening of the outlet tube. The apparatus also includes a plurality of hollow needles adapted to be connected to the manifold to receive the liquid pumped through the pump, through the outlet tube, and into the manifold.

Other aspects of the invention will be apparent from the following description and the appended claims.

### BRIEF DESCRIPTION OF DRAWINGS

FIG. 1 is a block diagram representing a basting and injection apparatus, in accordance with one or more embodiments.

FIG. 2A is a method of operating the basting and injection apparatus of FIG. 1, in accordance with one or more embodiments.

FIG. 2B is a method of manufacturing the basting and injection apparatus of FIG. 1, in accordance with one or more embodiments.

FIG. 3 is a specific example of a basting and injection apparatus, in accordance with one or more embodiments.

FIG. 4 is a circuit diagram useful for controlling a basting and injection apparatus, in accordance with one or more embodiments.

### DETAILED DESCRIPTION

Specific embodiments of the invention will now be described in detail with reference to the accompanying figures. Like elements in the various figures are denoted by like reference numerals for consistency.

In the following detailed description of embodiments of the invention, numerous specific details are set forth in order to provide a more thorough understanding of the invention. However, it will be apparent to one of ordinary skill in the art that the invention may be practiced without these specific details. In other instances, well-known features have not been described in detail to avoid unnecessarily complicating the description.

Throughout the application, ordinal numbers (e.g., first, second, third, etc.) may be used as an adjective for an element (i.e., any noun in the application). The use of ordinal numbers is not to imply or create any particular ordering of the elements nor to limit any element to being only a single element unless expressly disclosed, such as by the use of the terms “before”, “after”, “single”, and other such terminology. Rather, the use of ordinal numbers is to distinguish between the elements. By way of an example, a first element is distinct from a second element, and the first element may encompass more than one element and succeed (or precede) the second element in an ordering of elements.

In general, embodiments of the invention relate to food preparation aids, and more particularly to a basting and injection apparatus. Embodiments of the invention also relate to a method of using, and a method for manufacturing, the basting and injection apparatus. The one or more embodiments recognize that it may be inconvenient or undesirable to manually baste or inject a food product while it is being prepared. For example, it may be inconvenient or undesirable to pull a turkey out of an oven periodically during cooking in order to both baste the turkey's outside and to inject a basting liquid inside the turkey. The one or more embodiments address these and other food preparation issues.

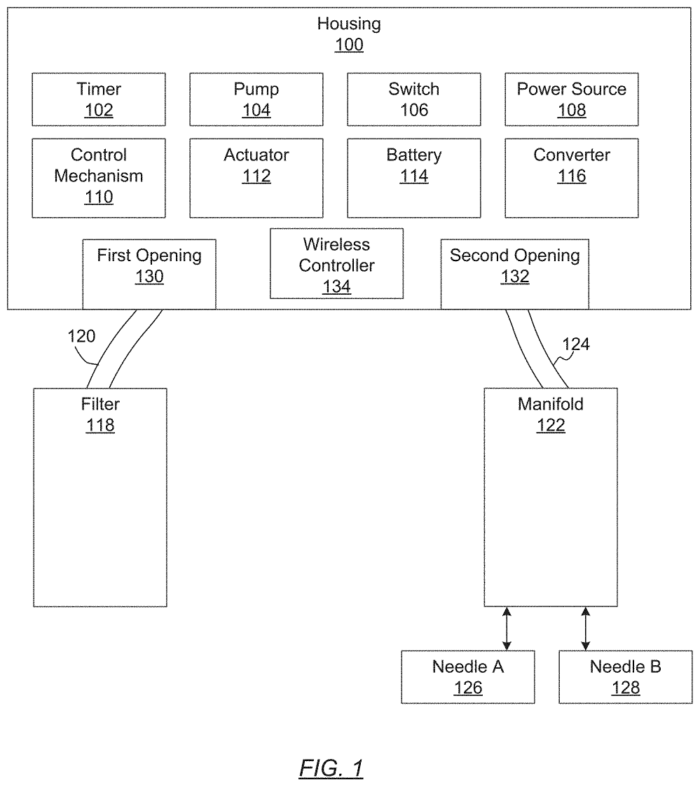

FIG. 1 is a block diagram representing a basting and injection apparatus, in accordance with one or more embodiments. The basting and injection apparatus shown in FIG. 1 includes a housing (100) for holding various components of the basting and injection apparatus. The housing may take many forms and may be constructed from a variety of materials. For example, the housing may be a plastic, composite, or metal box, and may be provided with a handle for portability. However, the housing could also be permanently mounted into a kitchen near an oven or stove, and thus could be a built-in box or shelf. The housing (100) need not be a box, but could be spherical or elliptical housing, or may assume any other convenient shape.

The housing includes a number of components. For example, the housing includes a timer (102), a pump (104), a switch (106), a power source (108), a control mechanism (110), and an actuator (112). In the case that the basting and injection apparatus includes more than one power source, the housing (100) may include a battery (114) and/or a power converter (116) for the power source (108). In other words, the power source (108) may be considered a single power source, or may be more than one power source.

The basting and injection apparatus shown in FIG. 1 may also include a filter (118) connected to the pump (104) inside the housing (100) via an inlet tube (120). The basting and injection apparatus may also include a manifold (122) connected to the pump (104) inside the housing (100) via an outlet tube (124). In turn, the manifold is connected to one or more needles, such as but not limited to Needle A (126) and Needle B (128).

Additional details regarding the above-described components are now addressed. The timer (102) may be connected to the housing (100), or may be disposed loosely within the housing (100). The timer (102) may be a time display observable outside the housing (100). For example, the housing (100) may have an opening that allows a user to observe the time displayed on the timer (102). Alternatively, the timer (102) may be mounted externally on the housing or otherwise disposed outside of or in the wall housing such that a user can see the display on the timer.

The timer may also include a control mechanism (110) for controlling operation of the timer. The control mechanism (110) may be used to set the time, and to set one or more specific times or triggers. For example, the control mechanism (110) may be buttons, dials, switches, etc. useable to set the timer. The control mechanism (110) could potentially be operable to monitor many different time periods, or even time periods selectable by selecting a food type. For example, the timer may receive an input that the food being prepared is “chicken” and then set the time intervals accordingly.

The timer (102) may take a number of different forms. For example, the timer (102) may be an analog timer or a digital timer. The timer (102) may include a multi-stage timer that tracks the first time interval and the second time interval. The timer may be programmable to individually set either or both the first time interval and the second time interval. When the timer (102) measures a set time, the timer (102) may generate a signal when the first time period expires, the second time period expires, or both.

Attention is now turned to the power source. As indicated above, the power source (108) may be one or more power sources used for providing power to one or more other components of the basting and injection apparatus. In one embodiment, the power source (108) may be an electric power source, such as a power supply which converts alternating current (AC) power from an electrical outlet into direct current (DC) power. In this case, the power source (108) optionally may also include a battery, such as a rechargeable or replaceable battery, which may be used either when basting and injection apparatus is and/or is not plugged into an electrical outlet. In another embodiment, one or more components of the power source (108) may be a solar panel or other alternative energy source.

The power source (108) may be operably connected to the timer (102), the pump (104), the switch (106), the control mechanism (110), and/or the actuator (112). In this context, the term “operably connected” means an electrical connection via lead, wire, etc. In the case that some of these components are mechanical analog devices, as opposed to digital or electrical devices, then the power source (108) need not be connected to one or more of these objects.

As indicated above, the power source (108) may be the battery (114) and the alternating current-direct current converter (116). In this case, the basting and injection apparatus may also include an electrical cord (not shown) connected to the alternating current-direct current converter (116) and configured to be plugged into an electrical outlet.

Attention is now turned to the pump (104). The pump (104) is disposed inside the housing and operably connected to the timer (102). The term “operably connected to the timer” means that an electrical or analog mechanism is attached between the pump (104) and the timer (102) so that a signal or mechanical actuation from the timer (102) may be transferred to the pump (104) in order to aid in controlling operation of the pump (104). For example, if the timer (102) is a digital timer, then the mechanism could be a conducting wire which conducts an electrical signal to the pump (104). However, if the timer (102) is an analog timer, then a physical mechanism (such as, but not limited to, a spring) may control operation of the pump (104).

However the timer (102) and the pump (104) are connected, the pump (104) is configured to pump a liquid (not shown). The liquid may be a baste, marinade, or some other liquid useful for basting or injecting the food product being prepared. The liquid is stored in a reservoir (not shown), from which the liquid is pumped through the pump (104) and back out of the housing, as described further below.

Attention is now turned to the switch (106). The switch (106) is operably connected to the timer and to the pump. The term “operably connected to the timer and to the pump” means that an electrical or analog mechanism is attached between the switch (106) and to the pump (104) and the timer (102) so that a signal or mechanical actuation from the switch (102) may be transferred to the pump (104) and/or the timer (102) in order to aid in controlling operation of the pump (104) and/or the timer (102). For example, the switch (106) may be configured to control operation of the pump according to a signal received from the timer. More specifically, the timer (102) may transmit the signal to the switch (106), when then switches the pump (104) on or off. In an embodiment, the switch (106) may be part of the pump (104), rather than a component separate from the pump (104).

In a specific example, the switch (106) may activate the pump (104) upon expiration of a first time interval, as measured by the timer (102). Additionally, the switch (106) may deactivate the pump (104) upon expiration of a second time interval. Thus, the timer and the switch acting in concert may engage the pump (104) at regular time intervals (the first time interval), with the pump switching off after a second time interval. In a specific example, the basting and injection apparatus could be controlled to pump liquid into the food product once every half hour for five minutes at a time.

Attention is now turned to the inlet tube (120). The inlet tube may be a flexible plastic tube, though may be an inflexible tube, and may be formed from a variety of different material in a variety of different shapes. The term “flexible” means that a human can bend the object in question by hand, possibly without breaking the object or interrupting the flow of fluid within the object.

The inlet tube (120) extends outwardly from the housing (100) through a first opening (130) in the housing (100). The inlet tube (120) is in fluid communication with the pump (104). The inlet tube (120) has a first opening and a second opening at opposing ends of the inlet tube (120). The inlet tube (120) may be connected to the pump (104) at the first opening of the inlet tube, with the inlet tube (120) extending outside the housing (100) through the first opening (130) in the housing (100) such that the second opening of the inlet tube (120) is external to the housing (100).

The opposing, second end, of the inlet tube (120) may be placed in the reservoir (not shown) which holds the liquid. In this manner, the second opening of the inlet tube (120) may be placed in the liquid. The pump (104) pumps liquid from the reservoir, through the inlet tube (120) and into the pump (104). Note that some pumps could operate to pump the liquid as described herein without the liquid actually entering the pump (104), such as in the case of a diaphragm pump.

In an embodiment, the filter (118) may be connected to the second opening of the inlet tube (120). The filter (118) may be configured to filter particles in the liquid. For example, the liquid might be a vegetable or meat stock which contains emulsified particles. In this case, the filter (118) may filter the emulsified particles from the liquid as the pump (104) pumps the liquid from the reservoir through the inlet tube (120).

Attention is now turned to the outlet tube (124). The outlet tube (124) has openings, characterized as third and fourth openings, at either end of the outlet tube (124). The outlet tube (124) is connected to the pump (104) at one end, such as at the third opening of the outlet tube. The outlet tube (124) extends outside the housing (100) through a second opening (132) in the housing such that the fourth opening of the outlet tube (124) is external to the housing (100).

Attention is now turned to the manifold (122). The manifold may include an inlet for receiving the liquid from the outlet tube (124). A chamber inside the manifold receives the liquid. The manifold (122) also includes one or more outlets through which the liquid may be distributed. The manifold (122) is connected to the outside opening of the outlet tube (124) (i.e., the fourth opening of the outlet tube (124)).

One or more hollow needles, such as Needle A (126) and Needle B (128) may be connected to the manifold (122). The needles are attached to the outlets of the manifold (122) in order to receive the liquid pumped through the pump (104), through the outlet tube (124), and into the manifold (122).

The needles may be plastic, metal, or any other convenient hollow needles. In an embodiment, the needles may be replaced with syringes, in which case the manifold (122) will also include a mechanism for depressing or otherwise applying additional pressure to the liquid before being injected into the food product.

In an embodiment, additional tubes are disposed between the manifold (122) and the needles. Ones of the additional tubes are connected to ones of the hollow needles. Stated differently, each manifold outlet may have an individually connected tube, which then connects to an individual hollow needle. In this manner, the additional tubes act like extenders, possibly flexible extenders, which allow the needles to be placed into different places with respect to the food product.

The basting and injection apparatus may include additional optional equipment. For example, the basting and injection apparatus may also include an actuator (112) connected to the switch (106) and configured to manually control the switch (106), and thereby manually control the pump. For example, the actuator (112) may be a button, a second switch, etc. When the actuator (112) is actuated, the switch (106) may be manually switched on or off, overriding any signal from the timer. In this manner, a user may turn the pump (104) and/or other components of the basting and injection apparatus on and off without regard to the operation of the timer (102). In an embodiment, the actuator (112) may be directly connected to the pump (104) to directly control operation of the pump.

In another embodiment, the basting and injection apparatus may also include a wireless controller (134) disposed in the housing (100) and connected to at least one of the switch (106), the timer (102), and the actuator (112). The wireless controller (134) is configured to communicate wirelessly with a remote device, and to control operation of the at least one of the switch (106), the timer (102), and the actuator (112).

In an alternative embodiment, the wireless controller (134) could be a wireless communication receiver in one or more of the timer (102), the pump (104), the switch (106), the power source (108), the control mechanism (110), and/or the actuator (112). In any of these cases, the wireless controller (134) may receive a remote signal which controls operation of the corresponding component of the basting and injection apparatus.

In a specific example, a user may have an application (i.e., a software program) on a mobile device or other computer which is designed to control operation of the basting and injection apparatus. The user may interact with the application, which then causes the mobile device to transmit a signal to set the timer (102) and/or to turn the pump (104) on or off via the actuator (112).

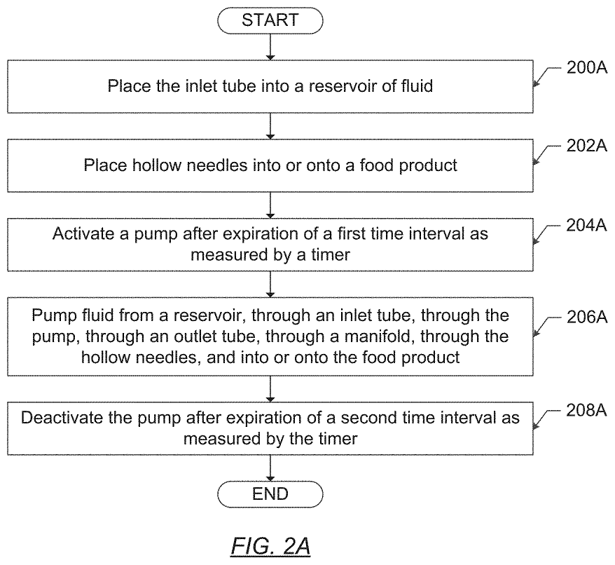

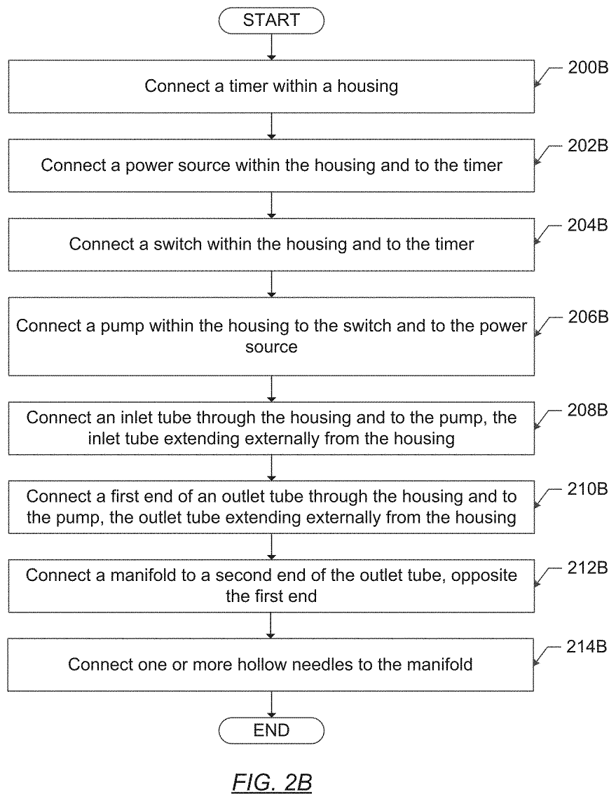

FIG. 2A is a method of operating the basting and injection apparatus of FIG. 1, in accordance with one or more embodiments. The method shown in FIG. 2A may be performed a user, or by an automatic machine which places the various components of the basting and injection apparatus and automatically sets the timer. Thus, while the method of FIG. 2A is described in the passive voice, it is assumed that the steps are performed by a user, an automatic machine, or a combination of both in which some steps are controlled by the user and other steps are controlled by the automatic machine.

At step 200A, the inlet tube is placed into a reservoir of fluid. As described above, the fluid is a basting fluid which includes, but is not limited to, pure water, brine, stock, broth, herbal infusions, etc. (During cleaning, the fluid may be a cleaning fluid, such as but not limited to soapy water, a vinegar and water solution, etc.)

At step 202A, the hollow needles are placed into or onto a food product. The needles may be inserted into a variety of different locations in the food product when the needles are connected to the manifold via additional flexible tubes. However, surface basting may be performed by laying the needles on the food product, by suspending the needles over the fool product, or, in some cases, by placing the needles underneath the food product.

At step 204A, the pump is activated after expiration of a first time interval as measured by a timer. In other words, the user sets the timer to determine when the pump should turn on. Alternatively, the user may manually turn on the pump or manually control the pump.

At step 206A, the fluid is pumped from the reservoir, through the inlet tube, through the pump, through the outlet tube, through the manifold, through the hollow needles, and into, onto, over, or around the food product. While pumping may be accomplished using a single pump, as described above, multiple pumps could be used. In the case of multiple pumps, multiple inlet tubes and multiple outlet tubes/manifolds/needles sets could be used. Alternatively or in addition, multiple pumps may be staged in order to provide increased pressure during pumping.

At step 208A, the pump is deactivated after expiration of a second time interval as measured by the timer. In other words, another signal from the timer may deactivate the pump after a pre-determined time. Alternatively, the pump may be deactivated manually or may be deactivated upon the trigger of some other event. Other triggers could be the amount of fluid pumped (i.e., pumping continues until a certain volume of fluid has been pumped as measured by a flow meter), the cessation or reduction of fluid flow (i.e., a blockage or a lack of remaining fluid is preventing the flow of fluid, etc.).

FIG. 2B is a method of manufacturing the basting and injection apparatus of FIG. 1, in accordance with one or more embodiments. The method shown in FIG. 2B may be performed a human technician, or by an automatic machine which connects the various components of the basting and injection apparatus. Thus, while the method of FIG. 2B is described in the passive voice, it is assumed that the steps are performed by a technician, an automatic machine, or a combination of both in which some steps are controlled by the user and other steps are controlled by the automatic machine. The steps shown in FIG. 2B need not be performed in the same order shown, and one or more steps could be performed concurrently.

At step 200B, a timer is connected within a housing. For example, the timer could be mounted to or within the housing, or otherwise could be placed loosely inside the housing.

At step 202B, a power source is connected within the housing and too the timer. For example, the power source could be mounted to or within the housing, or otherwise could be placed loosely inside the housing. Multiple parts of the power source could be present, as described above, such as both a battery and a power supply.

At step 204B, a switch is connected within the housing and too the timer. Again, the switch is used to control operation of the pump based on a signal from the timer.

At step 206B, a pump is connected within the housing to the switch and to the power source. The pump is powered by the power source and controlled by the switch.

At step 208B, an inlet tube is connected through the housing and to the pump. The inlet tube extends externally from the housing. A grommet or seal may be disposed at any hole existing in the housing for accommodating the inlet tube. In an embodiment, a spring and reel system may be added which takes up slack in the inlet tube for the portion of the inlet tube not currently pulled from the housing.

At step 210B, a first end of an outlet tube is connected through the housing and to the pump. The outlet tube extends externally from the housing. A grommet or seal may be disposed at any hole existing in the housing for accommodating the outlet tube. In an embodiment, a spring and reel system, perhaps the same one used with respect to the inlet tube, may be added which takes up slack in the outlet tube for the portion of the outlet tube not currently pulled from the housing.

At step 212B, a manifold is connected to a second end of the outlet tube, opposite the first end. In this manner, a fluid line exists between the inlet tube, the pump, the outlet tube, and the manifold.

At step 214B, one or more hollow needles are connected to the manifold. The needles may be connected directly to the manifold, or may be connected via additional tubes that are disposed between the needles and the manifold. If flexible tubes are used, then the user has flexibility in where the needles may be placed within the food product. In any case, fluid may flow from a reservoir, through the inlet tube, through the pump, through the outlet tube, through the manifold, through the needles or additional tubes, and into or onto the food product.

Note that the fluid might not pass through the pump itself, but could pass beside the pump, as in the case of a diaphragm pump pressing on a tube. In this case, the inlet tube and the outlet tube may be joined into a single tube which passes by the pump. Nevertheless, it is contemplated that in most pump embodiments, the fluid will pass through the pump.

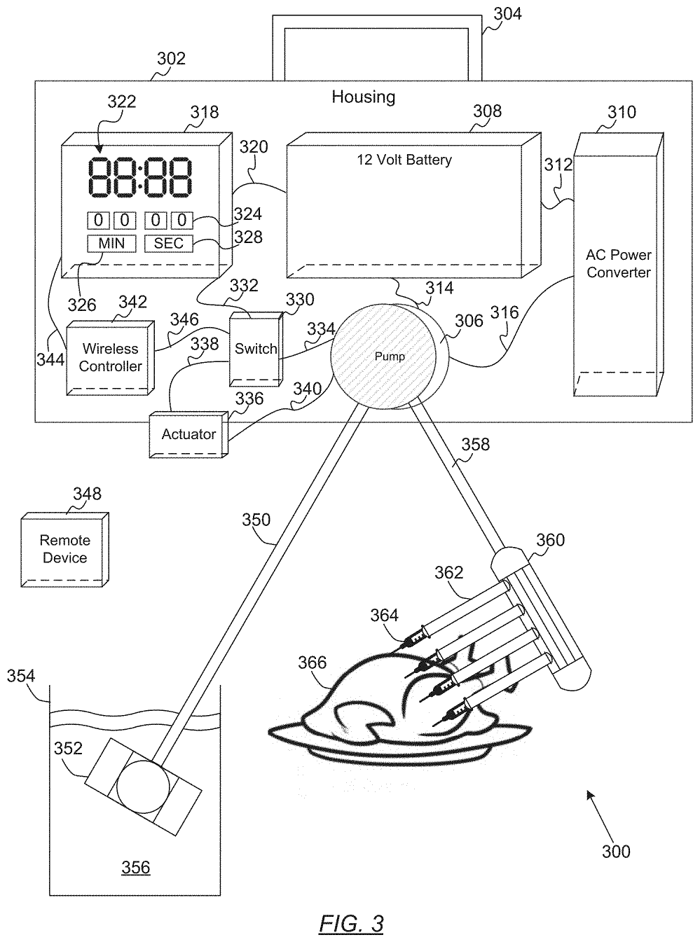

FIG. 3 is a specific example of a basting and injection apparatus, in accordance with one or more embodiments. FIG. 3 is a specific example of the basting and injection apparatus shown in FIG. 1, though other embodiments and arrangements of the various components are contemplated.

Basting and injection apparatus (300) includes housing (302) which houses or otherwise supports the other components of the basting and injection apparatus (300). In this specific, non-limiting example, the housing is a plastic container having a handle (304) for easy hand transport.

A pump (306) is disposed inside the housing (302). In this example, the pump (306) is mounted to a floor of the housing, though other arrangements are possible. The pump may be of a variety of different types, including peristaltic, centrifugal, diaphragm, positive displacement, suction, gear, compressor, and others. In a specific, non-limiting embodiment, the pump (306) may be a peristaltic F5T2 mini-dosing DC 12 volt pump with a flow rate of between about 19 and 100 milliliters per minute.

In a still different embodiment, a two-stage pump could be used in which the pump (306) is capable of two different pressures: a higher pressure and a lower pressure. In this embodiment, the pump (306) may be operated at the lower pressure while basting or injecting the food product (366). The pump (306) may be operated at the higher pressure level during cleaning. Cleaning the basting and injection apparatus (300) is described further, below. Still other embodiments are possible, and more than two pump stages could be used, different pump types could be used, etc.

The pump is powered by a power source that includes both a 12-volt battery (308) and an AC power converter (310). The term “AC” means “alternating current,” and an “AC power converter” converts AC current available from an electrical outlet into direct current (“DC” current) which is used by the pump (306). In an embodiment, the 12-volt battery (308) may be a rechargeable battery, in which case the AC power converter (310) may also recharge the 12-volt battery. In another embodiment, the 12-volt battery (308) may directly power the pump (306), and the AC power converter (310) is used to recharge the 12-volt battery (308). Electrical wires, such as wire (312), wire (314), and wire (316) may provide an electrical connection between the pump (306), the 12-volt battery (308), and the AC power converter (310).

The housing (302) may also include a timer (318) mounted therein. The timer (318) is powered by an electrical connection to the battery (308) via wire (320). The timer is a chronometer which may display various time values on display (322). The display (322) in this example is a digital display. The display (322) may show the current time, a first time interval as described above, a second time interval as described above, the time of day for the pump to be switched on or off, or other times. In an alternative embodiment, the display (322) may show more than one time, such as for example, both the current time of day as well as the time interval that is being adjusted.

Specifically, for example, second display (324) includes boxes for showing the value of a time threshold or a specific time of day to be set. In an embodiment, a label or additional display may be shown for the convenience of the user, such as “MIN” label (326) and “SEC” label (328). The term “MIN” means “minutes” and the term “SEC” means seconds in this example.

The housing (302) may also include a switch (330) mounted therein. The switch (330) is in electrical communication with the timer (318) via wire (332) and with the pump (306) via wire (334). As described above, the switch controls operation of the pump, such as turning the pump on or off or controlling the operating power level of the pump. Thus, for example, the switch (330) could control how much fluid pressure the pump will apply to the liquid.

The housing (302) may also include an actuator (336) mounted therein or connected via a button or flip-switch extending outwardly from the housing (302). The actuator (336) may be in electrical communication with the switch (330) via wire (338) and with the pump (306) via wire (340). The actuator (336) may be used to manually control operation of the switch (330) and/or the pump (306). Thus, for example, the actuator (336) may be used to turn the pump (306) on continuously, regardless of any signal from the timer (318). Such action may be desirable when a user desires to purge the fluid lines and the pump (306) by pumping cleaning fluids through the system.

Optionally, the housing (302) may also include a wireless controller (342) mounted therein. The wireless controller (342) may be in electrical communication with the timer (318) via wire (344) and/or with the switch (330) via wire (346). The wireless controller (342) may enable wireless communications with a remote device (348), such as a mobile phone, laptop, computer, tablet, etc.

An application on the remote device may be used to receive instructions regarding control and operation of the basting and injection apparatus (300). The instructions are converted into electrical signals by the application working in conjunction with the remote device (348), which are in turn received by the wireless controller (342). In this manner, a user may set the timer (318) and control the switch (330) remotely, may review remaining power in the 12-volt battery (308), or nay take other actions with respect to the basting and injection apparatus (300). Note that the wireless controller (342) may also possibly be electrically connected to other components, such as the power source, the pump (306), or the actuator (336), thereby enabling control over the operation of such components.

The basting and injection apparatus (300) may also include an inlet tube (350) extending from the housing (302). In this example, the inlet tube (350) is in fluid communication with the pump (306) and a filter (352) disposed at an end of the inlet tube (350). The inlet tube (350), although shown as being straight, may be flexible. The filter (352) and the end of the inlet tube (350) have been placed into a reservoir (354) which holds a fluid (356). In this example, the fluid (356) is a basting fluid, such as broth, brine, saline, water, stock, etc. However, the reservoir (354) could hold a cleaning fluid when the user decides to operate the basting and injection apparatus (300) in a manner which pumps a cleaning fluid through the system.

The filter (352) may be of a variety of different types, though preferably allows both fluids and small, flavor-enhancing particles through the filter in order to provide additional flavor to the food product. The term “small” means that the particles are small enough so as not to clog the filter (352), inlet and outlet tubes (350, 358), or the pump (306). The filter (352) may be, in a non-limiting embodiment, a screen-type filter that comes apart for easy cleaning.

Note that multiple reservoirs may be used. In this case, the filter (352) would be placed in whichever fluid reservoir is desired. Note also in another embodiment multiple filters could be present. For example, the inlet tube (350) could be connected to another manifold (not shown) with additional tubes, each terminating in another filter or in another reservoir. Thus, it is possible to pump multiple fluids at the same time.

The basting and injection apparatus (300) also includes an outlet tube (358) extending from the housing (302). In this example, the outlet tube (358) is in fluid communication with the pump (306) and a manifold (360) disposed at an end of the outlet tube (358). The outlet tube (358), although shown as being straight, may be flexible.

The manifold (360) may be of a variety of different types, and is not limited to a manifold with a single inlet and four outlets, as shown in FIG. 3. For example, the manifold (360) may have more exit ports than the number of additional tubes provided. If desirable, unused exit ports may be sealed. In a specific, non-limiting example, the manifold (360) may be a NITRA® pneumatic valve manifold with four stations and capable of sustaining pressures of up to 1000 pounds per square inch (PSI). However, other types of manifolds could be used.

In turn, a number of additional tubes extend from the manifold (360). The additional tubes may be flexible tubes or rigid tubes. Four additional tubes are shown, such as additional tube 362, however, more or fewer additional tubes may be present.

In turn, a number of hollow needles may be attached to some or all of the ends the additional tubes. Thus, for example, hollow needle (364) is attached to additional tube (362).

The hollow needles, may be placed inside, one, around, or under the food product (366). As an alternative to placing the hollow needles inside the food product (366), the hollow needles may be suspended over the food product (366), laid on top of the food product (366), placed under the food product, (366), etc. Some of the hollow needles may be placed in two or more of these alternative locations. In some cases, one or more of the hollow needles may not be present, in favor of allowing the open end of the additional tube and/or manifold opening to be suspended over, placed on, or placed under the food product (366).

While the food product (366) is shown as being a turkey, any food product could be used. Thus, the one or more embodiments may be used with a wide variety of food products.

Still other variations are possible. For example, the opening in the inlet tube (350) or the filter (352) may be placed underneath the food product (366). In this manner, drippings and fluids from the food product (366) during cooking may be taken up by the inlet tube (350) and pumped back into the food product via the pump (306), outlet tube (358), and manifold (360).

Still other alternatives are possible, such as the inlet tube (350) and outlet tube (358) being on different sides of the housing, or perhaps the tubes could have different lengths than shown, or perhaps the pump (306), 12-volt battery (308), AC power converter (310), timer (318), switch (330), and other components can be arranged differently than the arrangement shown in FIG. 3. Thus, the one or more embodiments are not necessarily limited by the example of FIG. 3.

In yet other variations, additional components may be provided in or connected to the basting and injection apparatus (300). For example, a thermometer (not shown) may be connected to, or disposed in, the housing (302). The thermometer, if electrical, may be connected the power source. The thermometer may to measure the temperature of the food product (366). An alarm (not shown) may be connected to, or disposed in, the housing (302) in order to indicate when the temperature of the food product (366) has reached a desired temperature.

In still another example, a moisture sensor may be connected to, or disposed in, the housing (302). The moisture sensor, if electrical, may be connected to the power source. The moisture sensor may measure the moisture level of the food product (366). The moisture sensor may also be connected to the switch (330) and/or the wireless controller (342) so that when a moisture level of the food product (366) falls below a threshold moisture level, an alarm may sound, or the pump (306) may be activated automatically in order to inject and/or baste the basting fluid into, on, around, or under the food product (366). Still other components may be connected to or added to the housing (302).

In use, the hollow needles, such as hollow needle (364) are placed into, on, around, and/or under the food product (366). Then, the filter (352) is placed into the reservoir (354) of a basting fluid (356). The pump (306) pumps the basting fluid (356) from the reservoir (354), though the inlet tube (350), through the pump (306), through the outlet tube (358), and through the manifold (360). The manifold (360) distributes the fluid to the multiple additional tubes, such as additional tube (362), and into the corresponding hollow needles, such as hollow needle (364). The basting fluid (356) then flows from the hollow needles into, on, around, and/or under the food product (366).

The basting and injection apparatus (300) may be cleaned by a variety of different methods. In an embodiment, a solution of vinegar and water may be placed into a clean reservoir (354). The actuator (336) may be then be activated in order to cause the pump (306) to continuously pump the solution through the filter (352), inlet tube (350), pump (306), outlet tube (358), additional tubes, and hollow needles. If desirable, a long, narrow bristle brush may be inserted into one or more of the filter (352), inlet tube (350), pump (306), outlet tube (358), manifold (360), the additional tubes, and the hollow needles. The bristle brush may be used to scrub particulate matter and/or grease or oils from the insides of these components.

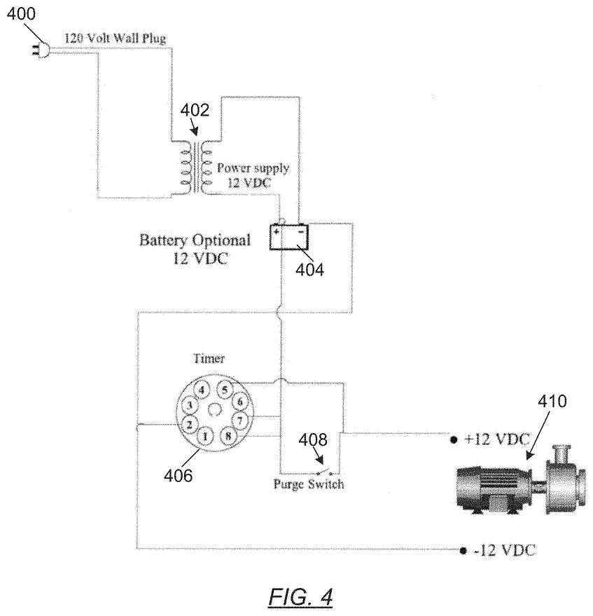

FIG. 4 is a circuit diagram useful for controlling a basting and injection apparatus, in accordance with one or more embodiments. The circuit diagram shown in FIG. 4 may be used with respect to the basting and injection apparatus (300) shown in FIG. 3.

A plug (400) suitable for insertion into a 120 volt wall AC electrical socket may be electrically connected to a transformer (402). The transformer (402) may be configured to transform the 120 volt AC electrical current into a 12 volt direct current.

In turn, the transformer (402) optionally may be connected to a battery (404), which may be a 12 volt direct current battery. The battery (404) may be a rechargeable battery.

In any case, an electrical signal of 12 volts direct current is electrically connected to a timer (406) and a purge switch (408). The timer (406) may be timer (318) in FIG. 3 and the purge switch (408) may be the actuator (336) in FIG. 3.

The battery (404), timer (406), and purge switch (408) are connected to a pump (410), which may be pump (306) in FIG. 3. The timer (406), the purge switch (408), and the pump (410) may be connected in parallel in some embodiments.

While the invention has been described with respect to a limited number of embodiments, those skilled in the art, having benefit of this disclosure, will appreciate that other embodiments can be devised which do not depart from the scope of the invention as disclosed herein. Accordingly, the scope of the invention should be limited only by the attached claims.

What is claimed is:

1. An apparatus comprising:
a housing;
a timer connected to the housing, the timer comprising a time display observable outside the housing and further comprising a control mechanism for controlling operation of the timer;
a pump disposed inside the housing and operably connected to the timer, the pump configured to pump a liquid;
a switch operably connected to the timer and to the pump, the switch configured to control operation of the pump according to a signal received from the timer;
a power source disposed inside the housing and operably connected to the pump;
an inlet tube having a first opening and a second opening, the inlet tube connected to the pump at the first opening of the inlet tube, and the inlet tube extending outside the housing through a first housing opening such that the second opening of the inlet tube is external to the housing;
an outlet tube having a third opening and a fourth opening, the outlet tube connected to the pump at the third opening of the outlet tube, the outlet tube extending outside the housing through a second housing opening such that the fourth opening of the outlet tube is external to the housing;
a manifold connected to fourth opening of the outlet tube; and
a plurality of hollow needles connected to the manifold to receive the liquid pumped through the pump, through the outlet tube, and into the manifold.

2. The apparatus of claim 1, further comprising:
a filter connected to the second opening of the inlet tube, the filter configured to filter particles in the liquid.

3. The apparatus of claim 1, further comprising:
a plurality of additional tubes, wherein ones of the plurality of additional tubes are connected to ones of the plurality of hollow needles.

4. The apparatus of claim 1 further comprising:
an actuator connected to the switch and configured to manually control the switch.

5. The apparatus of claim 1 further comprising:
an actuator connected to the pump and configured to manually control the pump.

6. The apparatus of claim 1, wherein the power source comprises a battery and an alternating current-direct current converter, and wherein the apparatus further comprises:
an electrical cord connected to the alternating current-direct current converter and configured to be plugged into an electrical outlet.

7. The apparatus of claim 1, wherein:
the timer comprises a digital timer,
the power source comprises an electric power source, and
the power source is connected to the timer.

8. The apparatus of claim 1, wherein the timer comprises a two-stage timer that tracks a first time interval and a second time interval.

9. The apparatus of claim 8, wherein the switch is configured to:
activate the pump upon expiration of the first time interval, and
deactivate pump upon expiration of the second time interval.

10. The apparatus of claim 9, wherein the timer is programmable to individually set both the first time interval and the second time interval.

11. The apparatus of claim 1, further comprising:
a wireless controller disposed in the housing and connected to at least one of the switch and the timer, wherein the wireless controller is configured to communicate wirelessly with a remote device, and to control operation of the at least one of the switch and the timer.

12. A method of manufacturing an apparatus, the method comprising:
connecting a timer within a housing;
connecting a power source within the housing and to the timer;
connecting a switch within the housing and to the timer;
connecting a pump within the housing to the switch and to the power source;
connecting an inlet tube through the housing and to the pump, the inlet tube extending externally from the housing;
connecting a first end of an outlet tube through the housing and to the pump, the outlet tube extending externally from the housing;
connecting a manifold to a second end of the outlet tube, opposite the first end;
connecting a plurality of hollow needles to the manifold.

13. The method of claim 12, wherein the inlet tube and the outlet tube are connected directly to the pump.

14. The method of claim 12, wherein:
the inlet tube is connected to a first fitting in a wall of the housing,
the first fitting is connected to a first fluid connection line connected to the pump,
the outlet tube is connected to a second fitting in the wall of the housing,
the second fitting is connected to a second fluid connection line connected to the pump,
the inlet tube is replaceably connected to the first fitting, and
the outlet tube is replaceably connected to the second fitting.

15. The method of claim 12, further comprising:
connecting a wireless controller in the housing to at least one of the timer and the switch.

16. An apparatus comprising:
a housing;
a timer, the timer comprising a time display and further comprising a control mechanism for controlling operation of the timer;
a pump disposed inside the housing and operably connected to the timer, the pump configured to pump a liquid;
a switch operably connected to the timer and to the pump, the switch configured to control operation of the pump according to a signal received from the timer;
an inlet tube having a first opening and a second opening, the inlet tube adapted to be connected to the pump at the first opening of the inlet tube, and adapted to extend outside the housing such that the second opening of the inlet tube is external to the housing;
an outlet tube having a third opening and a fourth opening, the outlet tube adapted to be connected to the pump at the third opening of the outlet tube, the outlet tube adapted to extend outside the housing such that the fourth opening of the outlet tube is external to the housing;
a manifold adapted to be connected to the fourth opening of the outlet tube; and
a plurality of hollow needles adapted to be connected to the manifold to receive the liquid pumped through the pump, through the outlet tube, and into the manifold.

17. The apparatus of claim 16, wherein the time display comprises a chronometer that displays at least one:
a first time interval,
a second time interval,
a time elapsed, and
a current time.

18. The apparatus of claim 17, wherein the signal is generated by the timer in response to at least one of:
expiration of the first time interval,
expiration of the second time interval,
a preselected amount of the elapsed time, and
the current time.

19. The apparatus of claim 18, wherein the signal comprises a first signal to turn on the pump at the expiration of the first time interval and to turn off the pump at the expiration of the second time interval.

20. The apparatus of claim 16, further comprising:
a wireless controller disposed in the housing and in communication with at least one of the switch and the timer, wherein the wireless controller is configured to communicate wirelessly with a remote device, and to control operation of the at least one of the switch and the timer.
